(19) United States
(12) Patent Application Publication
(10) Pub. No.: US 2017/0015484 A1
(43) Pub. Date: Jan. 19, 2017

(54) MOISTURE-ABSORBING MATERIAL, METHOD FOR PRODUCING SAME, AND BLISTER PACK

(71) Applicant: FUJIFILM CORPORATION, Tokyo (JP)

(72) Inventors: Hideki KAIMOTO, Shizuoka (JP); Naoko NAKAZAWA, Shizuoka (JP)

(21) Appl. No.: 15/276,805

(22) Filed: Sep. 27, 2016

Related U.S. Application Data
(63) Continuation of application No. PCT/JP2015/061391, filed on Apr. 13, 2015.

(30) Foreign Application Priority Data
Apr. 14, 2014 (JP) 2014-083199

(51) Int. Cl. B65D 81/26; B32B 3/30; B65D 75/34

(52) U.S. Cl. CPC B65D 81/267; B65D 75/34; B32B 3/30; B32B 2255/10; B32B 2255/26; B32B 2307/7246; B32B 2553/00

(57) ABSTRACT

An embodiment of the present invention provides a moisture-absorbing material including, in the following order, a moisture-permeable polymer layer, a moisture-absorbing layer having a porous structure and including amorphous silica, a water-soluble resin, a moisture-absorbing agent, and at least one selected from plasticizers and resins having a glass transition temperature of 50° C. or lower, and a moisture-proof layer.

### CROSS-REFERENCE TO RELATED APPLICATIONS

This application is a continuation application of International Application No. PCT/JP2015/061391, filed Apr. 13, 2015, which is incorporated herein by reference. Further, this application claims priority from Japanese Patent Application No. 2014-083199, filed Apr. 14, 2014, which is incorporated herein by reference.

### BACKGROUND OF THE INVENTION

1. Field of the Invention

The present disclosure relates to a moisture-absorbing material, a method for producing the same, and a blister pack.

2. Description of the Related Art

For preservation and transportation of medicines, foods, and the like, it is required to keep a space for storing medicines, foods, and the like in a state in which humidity is maintained in a predetermined range.

In consideration of such a requirement, in recent years, in order to maintain the humidity in a package for storing medicines, foods, and the like at a low level, a technique of using a moisture-absorbing sheet having hygroscopicity has been known. Specifically, a film for a press through package (PTP) blister formed by laminating a moisture-absorbing layer which contains a drying agent, and a barrier layer which is the outermost layer, and the like have been proposed (for example, refer to JP2006-327690A).

In addition, a method for producing a moisture-absorbing or moisture-proof sheet by applying a coating liquid including a moisture-absorbing agent, a binder, and a thickener to a support and drying the coating liquid has been disclosed. According to this method, it is possible to prevent desorption of the moisture-absorbing agent to obtain excellent dehumidification performance (for example, refer to JP2012-110818A). On the other hand, in order to prevent deterioration due to moisture absorption, storing a test chip containing a test agent in a cylindrical container made of a polyolefin resin into which a drying agent such as silica gel has been kneaded has been disclosed (for example, refer to JP2012-6649A).

Blister packs are generally used for storing medicines and the like. In order to reduce the influence of moisture on the stored material as much as possible, it is required that the material itself has excellent hygroscopicity.

### SUMMARY OF THE INVENTION

However, when the material itself is made porous or the moisture absorbing portion of the material is thickened in order to improve the hygroscopicity of the material itself, the material itself is likely to be brittle and thus a problem in that cracking may occur during molding or the like is likely to occur. In this manner, when there is an attempt to increase moisture absorbing performance, moldability tends to be impaired and thus hygroscopicity and moldability are typically in an antinomic relationship.

Therefore, a moisture-absorbing material having both high moisture absorbing performance and flexibility for withstanding molding has been expected. Such a material would be highly useful for a blister pack or the like.

The present disclosure is made in consideration of the above problems, and an object of an embodiment of the present invention is to provide a moisture-absorbing material having a large moisture absorption capacity and excellent transparency and capable of preventing a problem of cracking occurring during molding, a method for producing the same, and a blister pack.

The specific means for achieving the above object includes the following aspects. That is,

according to a first aspect of the present invention, there is provided

<1> a moisture-absorbing material comprising, in the following order: a moisture-permeable polymer layer; a moisture-absorbing layer having a porous structure and including amorphous silica, a water-soluble resin, a moisture-absorbing agent, and at least one selected from plasticizers and resins having a glass transition temperature of 50° C. or lower; and a moisture-proof layer.

<2> The moisture-absorbing material according to <1>, in which the plasticizer has a boiling point of 150° C. or higher.

<3> The moisture-absorbing material according to <1> or <2>, in which the plasticizer is a glycol-based compound.

<4> The moisture-absorbing material according to any one of <1> to <3>, in which the moisture-absorbing agent is an inorganic salt.

<5> The moisture-absorbing material according to <4>, in which the inorganic salt is calcium chloride.

<6> The moisture-absorbing material according to any one of <1> to <5>, in which the amorphous silica is vapor phase process silica.

<7> The moisture-absorbing material according to any one of <1> to <6>, in which the water-soluble resin is a polyvinyl alcohol-based resin.

<8> The moisture-absorbing material according to <7>, in which the polyvinyl alcohol-based resin is polyvinyl alcohol having a degree of saponification of 99% or less and a degree of polymerization of 3,300 or more.

<9> The moisture-absorbing material according to any one of <1> to <8>, in which the resin having a glass transition temperature of 50° C. or lower is a vinyl-based copolymer.

<10> The moisture-absorbing material according to <9>, in which the vinyl-based copolymer is at least one selected from a styrene-butadiene copolymer, an acrylic polymer, an ethylene-vinyl acetate copolymer, and a vinyl chloride-vinyl acetate copolymer.

<11> The moisture-absorbing material according to any one of <1> to <10>, in which a content of the plasticizer and the resin having a glass transition temperature of 50° C. or lower is 5% by mass or more and 15% by mass or less with respect to the amorphous silica.

<12> The moisture-absorbing material according to any one of <1> to <11> that is used for a blister pack.

According to a second aspect of the present invention, there is provided

<13> a blister pack comprising: the moisture-absorbing material according to any one of <1> to <12> in which a concave portion which becomes a storage portion is formed; and a substrate that is bonded to the polymer layer of a non-concave portion-forming portion on the side closer to the opening surface of the concave portion of the moisture-absorbing material.

According to a third aspect of the present invention, there is provided

<14> a method for producing a moisture-absorbing material comprising: forming a moisture-absorbing layer by forming a layer having a porous structure by applying a coating liquid including amorphous silica, a water-soluble resin, and at least one selected from plasticizers and resins having a glass transition temperature of 50° C. or lower to any one of a moisture-permeable polymer layer and a moisture-proof layer and applying a solution including a moisture-absorbing agent to the porous structure to impregnate the porous structure with the moisture-absorbing agent; and laminating the other one of the polymer layer and the moisture-proof layer on the moisture-absorbing layer impregnated with the moisture-absorbing agent.

<15> The method for producing a moisture-absorbing material according to <14>, in which the amorphous silica is vapor phase process silica.

According to the aspects of the present invention, it is possible to provide a moisture-absorbing material having a large moisture absorption capacity and excellent transparency and capable of preventing a problem of cracking occurring during molding, a method for producing the same, and a blister pack.

### BRIEF DESCRIPTION OF THE DRAWINGS

FIG. 1 is a schematic cross-section view showing an example of a lamination structure of a moisture-absorbing material according to an embodiment of the present invention.

FIG. 2 is a schematic cross-section view showing an example of a blister pack according to an embodiment of the present invention.

FIG. 3 is a view for illustrating an image example used for evaluation of visibility.

### DESCRIPTION OF THE PREFERRED EMBODIMENTS

Hereinafter, a moisture-absorbing material, a method for producing the same, and a blister pack formed using the same according to an embodiment of the present invention will be described in detail.

<Moisture-Absorbing Material>

A moisture-absorbing material according to an embodiment of the present invention has such a configuration that a moisture-permeable polymer layer, a moisture-absorbing layer having a porous structure and including amorphous silica, a water-soluble resin, a moisture-absorbing agent, and at least one selected from plasticizers and resins having a glass transition temperature of 50° C. or lower, and a moisture-proof layer are provided in this order.

Generally, it is important for the moisture-absorbing material to have high moisture absorbing performance. Thus, a technique of enhancing the hygroscopicity of a moisture-absorbing layer including a moisture-absorbing agent has been reviewed in the related art. In the case of forming the porous structure using amorphous silica to enhance the moisture absorbing performance of the moisture-absorbing layer, the layer simply made porous is likely to become hard and brittle and cracking is likely to occur during molding. The cracking of the moisture-absorbing layer impairs quality by strips adhering to one to be protected from a high humidity environment and also impairs the appearance of a molded product.

In the present disclosure, cracking can be effectively prevented from occurring in a moisture-absorbing layer having a porous structure by using one or two or more selected from plasticizers and resins having a glass transition temperature (Tg) of 50° C. or lower together with a water-soluble resin when the layer is made porous using amorphous silica.

The plasticizer and the resin having a low Tg impart flexibility to a layer hardened by incorporating amorphous silica thereinto while maintaining the pore shape of the hardened layer as it is, and the layer absorbs stress in the case of receiving external force so as to prevent breakage.

The moisture-absorbing rate of the moisture-absorbing material according to the embodiment of the present invention can be controlled by changing the thickness of the moisture-absorbing layer and the type of moisture-absorbing agent or by changing the thickness of an adhesive layer or the type of adhesive used for adhesion between layers when laminating each layer.

Hereinafter, the respective layers constituting the moisture-absorbing material will be described in detail.

—Moisture-Absorbing Layer—

The moisture-absorbing layer in the present disclosure has a porous structure and includes amorphous silica, a water-soluble resin, a moisture-absorbing agent, and at least one selected from plasticizers and resins having a glass transition temperature of 50° C. or lower.

The moisture-absorbing layer including amorphous silica and a water-soluble resin together with a moisture-absorbing agent has a three-dimensional structure having a high void volume. By adsorbing the moisture-absorbing agent to the amorphous silica surface having a three-dimensional structure, it is possible to hold moisture in voids of the moisture-absorbing layer having a large surface area in addition to the moisture absorption capacity of the moisture-absorbing agent. Accordingly, a wide moisture-absorbing surface can be ensured, and the moisture-absorbing rate is increased. Thus, it is considered that a large moisture absorption capacity can be obtained compared to a conventional moisture-absorbing material.

The moisture-absorbing rate of the moisture-absorbing layer can be controlled by changing the thickness of the layer and the type of moisture-absorbing agent.

(Plasticizer/Low Tg Polymer)

The moisture-absorbing layer in the present disclosure contains at least one selected from plasticizers and resins having a glass transition temperature (Tg) of 50° C. or lower (hereinafter, also referred to as “low Tg polymers”). When the moisture-absorbing layer contains a compound selected from plasticizers and low Tg polymers, flexibility to absorb external force is imparted to a layer having a relatively hard porous structure and cracking can be effectively prevented from occurring during molding and the like. In the case of the moisture-absorbing layer containing a low Tg polymer, when Tg is 50° C. or lower, cracking is effectively prevented from occurring.

Examples of the plasticizers include glycol-based compounds such as glycerol, ethylene glycol, diethylene glycol, triethylene glycol, and polyethylene glycol, phosphinic acid-compounds described in JP1971-2944A (JP-S46-2944A), polyalkylene oxide addition glycerin ether compounds described in JP1971-35972B (JP-S46-35972B), quaternary ammonium compounds having a hydroxyl group described in JP1975-35543B (JP-S50-35543B), amino compounds having an alkylene oxide added to ammonia and having a molecular weight of 500 or less described in JP1976-45620B (JP-S51-45620B), alkylene oxide adducts of isocyanuric acid described in JP1980-30019B (JP-S55-30019B), Michael-type reaction products of polyhydric alcohols or alkanolamines and acrylic esters described in JP1983-12301B (JP-S58-12301B), mono or dianhydrohexitols described in JP1985-156741A (JP-S60-156741A), and water-soluble polyglycidols having an alkyl group at its terminal end described in JP1986-98752A (JP-S61-98752A).

For the plasticizer, a compound having a boiling point of 150° C. or higher is preferable and from the viewpoint of incorporation into the layer, a high boiling point is more preferable than a low boiling point. Accordingly, the boiling point is more preferably 200° C. or higher and still more preferably 250° C. or higher. A boiling point of 150° C. or higher is suitable for allowing the compound to be present in the moisture-absorbing layer in a relatively stable state.

Among these, a glycol-based compound is preferable for the plasticizer, and the boiling point of the glycol-based compound is suitably 150° C. or higher. Further, glycerol, diethylene glycol, and polyethylene glycol are suitable for the plasticizer.

Examples of the reins having a glass transition temperature (Tg) of 50° C. or lower (low Tg polymers) include vinyl-based copolymers [(such as conjugated diene-based copolymers (for example, a styrene-butadiene copolymer, a methyl methacrylate-butadiene copolymer, and the like), and acrylic polymers (for example, a polymer or copolymer of (meth)acrylic acid ester, and the like), vinyl acetate copolymers (for example, an ethylene-vinyl acetate copolymer, a vinyl chloride-vinyl acetate copolymer, and the like)], or functional group modified copolymers obtained by modifying various vinyl-based copolymers with a functional group-containing monomer having a functional group such as a carboxyl group, and polyurethane resins, alkyd resins, unsaturated polyester resins, melamine resins, and urea reins.

Among these, vinyl-based copolymers having Tg of 50° C. or lower are preferable and among the vinyl-based copolymers, an ethylene-vinyl acetate copolymer, a vinyl chloride-vinyl acetate copolymer, a styrene-butadiene copolymer, and an acrylic polymer are more preferable.

The low Tg polymers are suitably used in the form of latex (water dispersion) of various resins. Specific examples of the latex of the low Tg polymers include NIPOL series manufactured by Zeon Corporation, PCL/SB latex series manufactured by JSR Corporation, VONCOAT series manufactured by DIC corporation, and EVA TEX series manufactured by Denka Company Limited, (for example, EVA TEX 60 and the like), and a low Tg type polymer can be selected among these and used.

The content of the plasticizer and the low Tg polymer in the moisture-absorbing layer is preferably 0.5% by mass or more and 30% by mass or less and more preferably 1% by mass or more and 20% by mass or less with respect to the total mass of the moisture-absorbing layer. When the content of the plasticizer and the low Tg polymer is 0.5% by mass or more, particularly, 1% by mass or more, the effect of preventing cracking from occurring in the layer is high. The content of the plasticizer and the low Tg polymer of 30% by mass or less is advantageous in terms of moisture absorption capacity and transparency.

The content of the plasticizer and the low Tg polymer refers to a total amount of one or two or more plasticizers, a total amount of one or two or more low Tg polymers, or a total amount of a plasticizer and a low Tg polymer.

In addition, the content of the plasticizer and the resin having a glass transition temperature of 50° C. or lower is preferably 5% by mass or more and 20% by mass or less, more preferably 5% by mass or more and 15% by mass or less, and still more preferably 5% by mass or more and 10% by mass or less with respect to the amorphous silica. When the content is 5% by mass or more, the content of the plasticizer and the low Tg polymer is not too low with respect to the amorphous silica and thus cracking is less likely to occur. When the content is 20% by mass or less, particularly, 15% by mass or less, the content of the plasticizer and the low Tg polymer is not too high with respect to the amorphous silica and thus it is advantageous in terms of moisture absorption capacity and transparency. Thus, excellent image visibility can be obtained.

(Amorphous Silica)

The moisture-absorbing layer in the present disclosure contains at least one type of amorphous silica.

The amorphous silica particles refer to porous amorphous particles in which a three-dimensional structure of SiO₂ is formed and is generally roughly classified into a wet process particle and a dry process (vapor phase process) particle according to the production method. Examples of the amorphous silica include synthetic amorphous silica such as vapor phase process silica obtained by a dry process and wet silica obtained by a wet process.

—Vapor Phase Process Silica—

The vapor phase process silica is silica (silica particles) obtained by evaporizing silicon chloride to synthesize silica particles by a vapor phase reaction in a hydrogen flame at a high temperature.

Since the vapor phase process silica has a low refractive index, transparency can be imparted to the moisture-absorbing layer by dispersing silica particles until an appropriate particle diameter is obtained. As described above, it is important that the moisture-absorbing layer is transparent from the viewpoint that the contents of a packaging can be visually checked and an indicator function or the like can be provided.

In addition, the vapor phase process silica is different from wet silica in the density of silanol groups on the surface and the present of absence of voids and exhibits different properties from the properties of wet silica. However, the vapor phase process silica is suitable for forming a three-dimensional structure having a high void volume. Although the reason is not clear, in the case of wet silica, the density of silanol groups on the surface of the particles is as high as 5 pieces/nm² to 8 pieces/nm² and the silica particles are likely to form dense aggregates. On the other hand, in the case of vapor phase process silica, the density of silanol groups on the surface of the particles is as low as 2 pieces/nm² to 3 pieces/nm² and thus the silica particles form loose soft flocculates. As a result, it is assumed that a porous structure having a high void volume is formed.

As the vapor phase process silica included in the moisture-absorbing layer, a vapor phase process silica having a density of silanol groups of 2 pieces/nm² to 3 pieces/nm² on the surface thereof is preferable.

The average primary particle diameter of the vapor phase process silica included in the moisture-absorbing layer is not particularly limited. From the viewpoint of transparency of the moisture-absorbing layer, the average primary particle diameter is preferably 20 nm or less and more preferably 10 nm or less.

The average secondary particle diameter of the vapor phase process silica included in the moisture-absorbing layer is preferably 50 nm or less and more preferably 25 nm or less from the viewpoint of transparency of the moisture-absorbing layer. In addition, from the viewpoint of transparency of the moisture-absorbing layer, a uniform secondary particle diameter distribution is preferable and the standard deviation in the secondary particle diameter distribution is preferably 10 nm or less, more preferably 8 nm or less, and particularly preferably 5 nm or less.

The average primary particle diameter in the present disclosure refers to an average particle diameter of primary particles obtained by obtaining the projected area of each of 100 silica particles by observing the surface of the moisture-absorbing layer with a transmission electron microscope, obtaining the diameter when assuming a circle having an area equal to the projected area, and simply averaging the diameters of 100 silica particles to obtain an average primary particle diameter.

Further, the average secondary particle diameter in the present disclosure refers to an average particle diameter of secondary particles obtained by obtaining the projected area of each of 100 aggregated particles by observing the surface of the moisture-absorbing layer with a scanning electron microscope, obtaining the diameter in the case of assuming a circle having an area equal to the projected area, and simply averaging the diameters of 100 aggregated particles to obtain an average secondary particle diameter.

Examples of the vapor phase process silica include AEROSIL (manufactured by Nippon Aerosil Co., Ltd.), REOLOSIL (manufactured by Tokuyama Corporation), WAKER HDK (manufactured by Asahi Kasei Corporation), and CAB-O-SIL (manufactured by CABOT Corporation), and AEROSIL300SF75 (manufactured by Nippon Aerosil Co., Ltd.) is preferable.

—Wet Silica—

The wet silica is a hydrous silica obtained by producing active silica by acid decomposition of silicate and aggregating and precipitating the silica through moderate polymerization.

The wet silica is classified into precipitation process silica, gel process silica, and sol process silica according to the production method. In the case of the precipitation process silica, silica particles which have been produced by reacting sodium silicate with sulfuric acid under alkaline conditions and have undergone particle growth are subjected to aggregation/precipitation, and then are subjected to steps of filtration, water washing, drying and pulverization/classification, to provide final products. Examples of the precipitation process silica include NIPSIL manufactured by Tosoh Silica Corporation, and TOKUSIL manufactured by Tokuyama Corporation. In addition, the gel process silica is obtained by reacting sodium silicate with sulfuric acid under acidic conditions. Specific examples thereof include NIPGEL manufactured by Tosoh Silica Corporation, and SYLOID and SYLOJET manufactured by Grace Japan Co., Ltd.

The average secondary particle diameter of the wet silica is preferably 10 μm or less from the viewpoint of transparency of the moisture-absorbing layer.

The specific surface area of the amorphous silica included in the moisture-absorbing layer by a BET method is preferably 200 m²/g or more and more preferably 250 m²/g or more. When the specific surface area of the vapor phase process silica is 200 m²/g or more, it is possible to maintain the transparency of the moisture-absorbing layer at a high level.

The BET method in the present disclosure refers to a method of measuring the surface area of a powder by a vapor phase adsorption method, and is a method of obtaining a total surface area of 1 g of a sample, that is, a specific surface area from an adsorption isotherm. Typically, as an adsorbing gas, nitrogen gas is frequently used. The amount of adsorption is determined from the variation in the pressure or volume of the adsorbed gas in most cases. The most remarkable equation for representing isotherm polymolecular adsorption is a Brunauer Emmett Teller equation or so-called BET equation, which is widely used for determining the surface area. The amount of adsorption is determined on the basis of the BET equation, and is multiplied by a surface area of one adsorbed molecule to determine the surface area.

The content of the amorphous silica in the moisture-absorbing layer is 20% by mass to 80% by mass and more preferably 30% by mass to 70% by mass with respect to the total solid content of the moisture-absorbing layer from the viewpoint of moisture absorption capacity and transparency of the moisture-absorbing layer.

As dispersing means for realizing the secondary particle diameter of the vapor phase process silica in the moisture-absorbing layer in the present disclosure, the addition of a dispersing agent is preferable and for example, a cationic polymer may be used. Examples of the cationic polymer include examples of mordants described in paragraphs [0138] to [0148] in JP2006-321176A.

As a dispersing method for realizing the secondary particle diameter of the vapor phase process silica, for example, various conventionally known dispersing machines such as a high speed rotary disperser, a medium stirring type disperser (a ball mill, a sand mill, a beads mill, and the like), a supersonic disperser, a colloid mill disperser, and a high pressure disperser can be used. Among these, a beads mill disperser and a liquid-liquid impact type disperser are preferable and a liquid-liquid impact type disperser is more preferable. An example of the liquid-liquid impact type disperser is ALTIMIZER (manufactured by Sugino Machine Limited).

(Water-Soluble Resin)

The moisture-absorbing layer in the present disclosure contains at least one water-soluble resin.

Since the water-soluble resin is incorporated into the moisture-absorbing layer in the state in which the vapor phase process silica is suitably dispersed, layer strength is further improved.

The water-soluble resin in the present disclosure refers to a resin that is finally dissolved in an amount of 0.05 g or more, preferably in an amount of 0.1 g or more, in 100 g of water at 20° C. though a heating or cooling step.

Examples of the water-soluble resin include a polyvinyl alcohol-based resin having a hydroxy group as a hydrophilic structure unit (such as polyvinyl alcohol (PVA), acetoacetyl modified polyvinyl alcohol, cation modified polyvinyl alcohol, anion modified polyvinyl alcohol, silanol modified polyvinyl alcohol, and polyvinyl acetal), a cellulose-based resin (such as methyl cellulose (MC), ethyl cellulose (EC), hydroxy ethyl cellulose (HEC), carboxy methyl cellulose (CMC), hydroxy propyl cellulose (HPC), hydroxyethylmethyl cellulose, and hydroxypropylmethyl cellulose), chitins, chitosans, starches, a resin having an ether bond (such as polypropylene oxide (PPO), polyethylene glycol (PEG), and polyvinyl ether (PVE)), and a resin having a carbamoyl group (such as polyacrylamide (PAAM), polyvinyl pyrrolidone (PVP), and polyacrylic acid hydrazide). In addition, a polyacrylic acid salt having a carboxyl group as a dissociating group, a maleic acid resin, an alginic acid salt, and gelatins may also used.

Among the water-soluble resins, from the viewpoint of film strength of the moisture-absorbing layer, a polyvinyl alcohol-based resin is preferable and polyvinyl alcohol is particularly preferable.

It is known that the glass transition temperature (Tg) of polyvinyl alcohol that is generally used varies depending on degree of saponification, and for example, is in a range from 58° C. (partial saponification) to 85° C. (full saponification) as described in DENKA POVAL catalog from Denka Company Limited. Therefore, the Tg of the polyvinyl alcohol used in the present disclosure is higher than at least 50° C. and the polyvinyl alcohol is distinguished from the aforementioned resin having a glass transition temperature of 50° C. or lower.

The degree of polymerization of the water-soluble resin is preferably 1,500 or more, more preferably 2,000 or more, and still more preferably 3,300 or more. In addition, the degree of polymerization is preferably 4,500 or less.

Among these, from the viewpoint of film strength of the moisture-absorbing layer, it is preferable that the water-soluble resin is a polyvinyl alcohol-based resin and the degree of polymerization of the polyvinyl alcohol-based resin is 1,800 or more. The degree of polymerization of the polyvinyl alcohol-based resin is more preferably 3,300 or more. Further, the degree of polymerization of the polyvinyl alcohol-based resin is preferably 5,000 or less and more preferably 4,500 or less.

The degree of saponification of the water-soluble resin is preferably 99% or less, more preferably 96% or less, and still more preferably 90% or less. In addition, the degree of saponification thereof is preferably 70% or more, more preferably 78% or more, and still more preferably 85% or more.

Among these, from the viewpoint of transparency of the moisture-absorbing layer, it is preferable that the water-soluble resin is a polyvinyl alcohol-based resin and the degree of saponification of the polyvinyl alcohol-based resin is 70% or more and 99% or less. The degree of saponification of the polyvinyl alcohol-based resin is more preferably 78% or more and 99% or less and the degree of saponification of the polyvinyl alcohol-based resin is still more preferably 85% or more and 99% or less.

The degree of saponification of the water-soluble resin of 70% or more is suitable for maintaining water solubility in practical use.

Furthermore, it is preferable that the water-soluble resin is polyvinyl alcohol. In this case, the degree of saponification and the degree of polymerization are preferably within the following ranges. That is,

in the case of using boric acid as a crosslinking agent for the polyvinyl alcohol, the degree of saponification of the polyvinyl alcohol is preferably within a range of 78% or more and 99% or less, and the degree of polymerization thereof is preferably within a 1,500 or more and 4,500 or less and more preferably within a range of 2,400 or more and 3,500 or less.

On the other hand, in the case of not using a crosslinking agent for the polyvinyl alcohol, it is preferable that the degree of saponification of the polyvinyl alcohol is low and the degree of polymerization is high from the viewpoint of being able to from the same porous structure as in the case of using a crosslinking agent. The degree of saponification of the polyvinyl alcohol is preferably within a range of 78% or more and 99% or less and the degree of polymerization of the polyvinyl alcohol is preferably within a range of 2,400 or more and 4,500 or less.

Among these, it is more preferable to constitute the moisture-absorbing layer in the present disclosure such that a glycol-based compound is used for the plasticizer or the low Tg polymer and polyvinyl alcohol is used for the water-soluble resin, and it is still more preferable to constitute the moisture-absorbing layer such that a glycol-based compound having a boiling point of 200° C. or higher is used for the plasticizer or the low Tg polymer and a polyvinyl alcohol having a degree of saponification of 78% or more and 99% or less and having a degree of polymerization of 2,400 or more and 3,500 or less is used for the water-soluble resin.

The water-soluble resin includes derivatives of the above specific examples and one water-soluble resin or a combination of two or more water-soluble resins may be contained in the moisture-absorbing layer.

The content of the water-soluble resin in the moisture-absorbing layer (in the case of using two or more water-soluble resins in combination, the total amount thereof) is preferably 4.0% by mass or more and 16.0% by mass or less and more preferably 6.0% by mass or more and 14.0% by mass or less from the viewpoints of preventing a decrease in film strength and cracking occurring during drying, which is caused by an excessively low content thereof, and preventing a reduction in hygroscopicity that results from a decrease in void volume due to an increased tendency for voids to be clogged by the resin, which is caused by an excessively high content thereof, with respect to the total solid content of the moisture-absorbing layer.

In addition, in the case of using polyvinyl alcohol as the water-soluble resin and using boric acid as a crosslinking agent for the polyvinyl alcohol, the content of the polyvinyl alcohol in the moisture-absorbing layer is preferably 10% by mass or more and 60% by mass or less and more preferably 15% by mass or more and 30% by mass or less with respect to the amount of the amorphous silica. In the case of using polyvinyl alcohol as the water-soluble resin and not using a crosslinking agent for the polyvinyl alcohol, the content of the polyvinyl alcohol in the moisture-absorbing layer is preferably within a range of 25% by mass or more and 60% by mass or less with respect to the amount of the amorphous silica.

The water-soluble resin has a hydroxyl group in the constituent unit thereof and this hydroxyl group and the silanol group on the surface of the vapor phase process silica forms a hydrogen bond so that a three-dimensional network structure having the secondary particles of the vapor phase process silica as chain units is easily formed. It is considered that a moisture-absorbing layer having a porous structure having a high void volume can be formed due to the formation of the three-dimensional network structure. It is presumed that the obtained moisture-absorbing layer having a porous structure functions as a layer holding moisture after moisture absorption.

(Crosslinking Agent)

The moisture-absorbing layer in the present disclosure may contain at least one crosslinking agent. The moisture-absorbing layer preferably adopts an embodiment having a porous structure and cured by the crosslinking reaction of the water-soluble resin (for example, polyvinyl alcohol).

As the crosslinking agent, suitable crosslinking agents may be appropriately selected in consideration of the water-soluble resin included in the moisture-absorbing layer. Among these, a boron compound is preferable from the viewpoint of enabling the prompt crosslinking reaction, and examples of the boron compound include borax, boric acid, borate (for example, orthoborate, InBO₃, ScBO₃, YBO₃, LaBO₃, Mg₃(BO₃)₂, and Co₃(BO₃)₂), diborate (for example, Mg₂B₂O₅, and Co₂B₂O₅), metaborate (for example, LiBO₂, Ca(BO₂)₂, NaBO₂, and KBO₂), tetraborate (for example, Na₂B₄O₇.10H₂O), and pentaborate (for example, KB₅O₈.4H₂O, Ca₂B₆O₁₁.7H₂O, and CsB₅O₅).

Among these boron compounds, from the viewpoint of enabling the prompt crosslinking reaction, borax, boric acid, and borate are preferable and boric acid is particularly preferable. The boron compound is most preferably used in combination with the polyvinyl alcohol-based resin that is suitably used as the water-soluble resin.

On the other hand, from the viewpoint of environmental suitability, the moisture-absorbing layer may not contain boric acid.

The content of the boron compound in the moisture-absorbing layer is preferably within a range of 0.15% by mass or more and 5.80% by mass or less, and more preferably within a range of 0.75% by mass or more and 3.50% by mass or less with respect to 4.0% by mass or more and 16.0% by mass or less of the polyvinyl alcohol. When the content of the boron compound is within the above range, the crosslinking of the polyvinyl alcohol is effectively performed and the effect of preventing cracking and the like is excellent.

In the case of using gelatin as the water-soluble resin or the like, the following compounds can be also used as the crosslinking agent (hereinafter, also referred to as “other crosslinking agents”) in addition to the boron compound.

Examples of the other crosslinking agents include aldehyde-based compounds such as formaldehyde, glyoxal and glutalaldehyde; ketone-based compounds such as diacetyl and cyclopentanedione; activated halogen compounds such as bis(2-chloroethylurea)-2-hydroxy-4,6-dichloro-1,3,5-triazine, and 2,4-dichloro-6-S-triazine sodium salt; activated vinyl compounds such as divinyl sulfonic acid, 1,3-vinylsulfonyl-2-propanol, N, N′-ethylene bis(vinylsulfonyl acetamido), 1,3,5-triacryloyl-hexahydro-S-triazine; N-methylol compound such as dimethylol urea and methyloldimethylhydantoin; melamine resin (for example, methylol melamine and alkylated methylol melamine); epoxy resin; isocyanate compounds such as 1,6-hexamethylene diisocyanate; aziridine-based compounds described in U.S. Pat. No. 3,017,280A and U.S. Pat. No. 2,983,611A; carboxyimide-based compounds described in U.S. Pat. No. 3,100,704A; epoxy-based compounds such as glycerol triglycidyl ether; ethyleneimine-based compounds such as 1,6-hexamethylene-N, N′-bis ethylene urea; halogenated carboxy aldehyde-based compounds such as mucochlor acid and mucophenoxychlor acid; dioxane-based compounds such as 2,3-dihydroxy dioxane; metal-containing compounds such as titanium lactate, aluminum sulfate, chrome alum, potassium alum, zirconyl acetate and chrome acetate, polyamine compounds such as tetraethylenepentamine, hydrazide compounds such as adipic dihydrazide, and low molecular weight compounds or polymers or the like which contains two or more oxazollin groups. The cross-linking agent may be used alone or in combination of two or more thereof.

(Moisture-Absorbing Agent)

The moisture-absorbing layer in the present disclosure contains at least one moisture-absorbing agent.

Examples of the moisture-absorbing agent include silica gel, zeolite, water absorbing polymers, and hygroscopic salts, and from the viewpoint of the moisture-absorbing rate, hygroscopic salts are preferable.

Specific examples of the hygroscopic salts include halogenated metal salts such as lithium chloride, calcium chloride, magnesium chloride, and aluminum chloride, metal sulfates such as sodium sulfate, potassium sulfate, magnesium sulfate, and zinc sulfate, metal acetates such as potassium acetate, amine salts such as dimethylamine hydrochloride, phosphate compounds such as orthophosphoric acid, guanidine salts such as guanidine hydrochloride, guanidine phosphate, guanidine sulfamate, guanidine methylolphosphate, guanidine carbonate, potassium hydroxide, sodium hydroxide, and magnesium hydroxide. Among these, from the viewpoint of moisture absorption capacity, calcium chloride is preferable.

The amount of the moisture-absorbing agent applied is preferably 1 g/m² or more and 20 g/m² or less, more preferably 2.5 g/m² or more and 15 g/m² or less, and particularly preferably 5 g/m² or more and 13 g/m² or less from the viewpoint of obtaining satisfactory moisture absorption capacity and transparency.

The thickness of the moisture-absorbing layer in the present disclosure is preferably 20 μm or more and 50 μm or less, more preferably 25 μm or more and 45 μm or less, and particularly preferably 30 μm or more and 45 μm or less from the viewpoint of obtaining satisfactory moisture absorption capacity and transparency. When the thickness of the moisture-absorbing layer is within the above range, it is possible to obtain a larger moisture absorption capacity and satisfactory transparency.

The void volume of the moisture-absorbing layer in the present disclosure is preferably 45% or more and 85% or less, more preferably 50% or more and 80% or less, and particularly preferably 55% or more and 75% or less. When the void volume of the moisture-absorbing layer is 45% or more, it is possible to obtain a larger moisture absorption capacity and when the void volume of the moisture-absorbing layer is 85% or less, it is possible to prevent a decrease in film strength and to prevent formation of cracks during drying.

As an example of a method for measuring the void volume, a method including measuring a void volume from a change in mass of a moisture-absorbing layer by a mercury intrusion method or by immersing the moisture-absorbing layer in an organic solvent such as diethylene glycol, and measuring the thickness of the moisture-absorbing layer by observing the cross-section of the moisture-absorbing layer with a microscope to calculate a void volume can be used.

It is preferable that the thickness of the moisture-absorbing layer in the present disclosure is 20 μm or more and 50 μm or less and the void volume thereof is 45% or more and 85% or less.

The average pore diameter of the moisture-absorbing layer in the present disclosure is preferably 40 nm or less, more preferably 30 nm or less, and particularly preferably 25 nm or less from the viewpoint of moisture absorption capacity. When the average pore diameter of the moisture-absorbing layer is 40 nm or less, sufficient transparency is obtained.

The average pore diameter is a value measured by a mercury intrusion method using Shimadzu AUTOPORE 9220 (manufactured by Shimadzu Corporation).

—Content Ratio Between Amorphous Silica and Water-Soluble Resin in Moisture-Absorbing Layer—

The content ratio between the amorphous silica (x) and the water-soluble resin (y) in the moisture-absorbing layer of the present disclosure [PB ratio (x/y), the mass of the amorphous silica with respect to 1 part by mass of the water-soluble resin] has a significant influence on the layer structure of the moisture-absorbing layer in some cases. That is, as the PB ratio increases, the void volume and pore volume increase.

Specifically, the PB ratio (x/y) of the moisture-absorbing layer is preferably 1.5/1 to 10/1 from the viewpoints of preventing a decrease in the layer strength and cracking during drying, which are caused by excessively high PB ratios, and preventing a reduction in moisture absorption capacity that results from a decrease in void volume due to an increased tendency for voids to be clogged by the resin, which is caused by excessively low PB ratios. In addition, the PB ratio of the moisture-absorbing layer is more preferably 1.5/1 to 8/1 from the viewpoint of effectively enhancing the effect of preventing a decrease in the film strength and cracking during drying.

In the case of using the moisture-absorbing material as a packaging material, from the viewpoint of protecting the contents, the moisture-absorbing layer is required to have a sufficient film strength. Moreover, the sufficient film strength of the moisture-absorbing layer is also required from the viewpoint of preventing cracking, peeling, and the like of the moisture-absorbing layer in the case in which the moisture-absorbing material is cut into films. From the viewpoint of these cases, the PB ratio (x/y) of the moisture-absorbing layer is preferably 10/1 or less.

For example, when a coating liquid, prepared by completely dispersing vapor phase process silica having an average primary particle diameter of 10 nm or less and the polyvinyl alcohol with a high degree of saponification at a PB ratio (x/y) of 1.5/1 to 10/1 in an aqueous solution, is applied onto a support and the resultant coating layer is dried, a three-dimensional network structure which has secondary particles of the silica particles as chain units is formed, whereby a film having an average pore diameter of 20 nm or less, a void volume of 45% or more and 85% or less, and a porous structure with high transparency can be easily formed.

—Polymer Layer—

The moisture-absorbing material according to the embodiment of the present invention has a moisture-permeable polymer layer.

The expression “moisture-permeable” of the polymer layer means that the moisture permeability of the polymer layer is within a range of 1 g/m²·day or more and 50 g/m²·day or less. The moisture permeability is a value measured by a method prescribed in JIS Z 0208.

The polymer layer includes at least a polymer and may include other components as required.

Examples of the type of the polymer include a linear low density polyethylene (LLDPE), a low density polyethylene (LDPE), a high density polyethylene (HDPE), a cast polypropylene (CPP), a biaxially oriented polypropylene (OPP), and a polyacrylonitrile (PAN). Particularly, from the viewpoint of versatility, LLDPE and CPP are preferable and CPP is more preferable.

The polymer layer can be prepared by applying a polymer solution of a commercially available heat sealing agent in the market through a dry lamination step or the like, and drying the solution. Examples of the commercially available heat sealing agent include AD-X17-3 and AD-76H5 manufactured by Toyo-Morton, Ltd., DICSEAL A series manufactured by DIC Corporation, and T-235 (L) CLEAR manufactured by Leader Co., Ltd.

The thickness of the polymer layer is 1 μm or more and 100 μm or less, more preferably 2 μm or more and 80 μm or less, and still more preferably 3 μm or more and 50 μm or less. When the thickness of the polymer layer is within the above range, both the handleability of the entire moisture-absorbing material and the handleability in the case in which the moisture-absorbing material is formed into a packaging material or the like can be achieved at a higher level.

The moisture-absorbing rate of the polymer layer into the moisture-absorbing layer in the present disclosure can be controlled by changing the material and the thickness.

In the case in which the moisture-absorbing material according to the embodiment of the present invention is used as a packaging material, the polymer layer can be used as an adhesion site.

—Moisture-Proof Layer—

The moisture-absorbing material according to the embodiment of the present invention further includes a moisture-proof layer on the moisture-absorbing layer on the polymer layer.

The moisture-proof layer in the present disclosure is not particularly limited as long as the layer includes a moisture-proof material. The moisture-proof layer is preferably a layer having a moisture permeability of 1 g/m²·day or less. The moisture permeability is a value measured by a method prescribed according to JIS Z 0208.

For the moisture-proof layer, one material may be used or a laminate of two or more materials may used. For example, for the moisture-proof layer, a material on which metal is deposited in advance may be used.

As the moisture-proof material, from the viewpoint of moisture-proof properties, a polyvinyl chloride (PVA), a silica-deposited film or an alumina-deposited film is preferably used. In addition, an aluminum foil or an aluminum-deposited film which has high moisture-proof properties may be used. A commercially available moisture-proof material may be used and examples thereof include TECH BARRIER MX (silica-deposited PET) manufactured by Mitsubishi Plastics, Inc. and BARRIALOX (alumina-deposited PET) manufactured by Toray International, Inc.

The thickness of the moisture-proof layer is preferably 6 μm to 300 μm and more preferably 6 μm to 250 μm from the viewpoint of moisture-proof properties.

—Adhesive Layer—

The moisture-absorbing material according to the embodiment of the present invention may have an adhesive layer between layers (for example, between the moisture-absorbing layer and the moisture-proof layer).

The adhesive layer preferably has moisture permeability and the moisture-absorbing rate of the moisture-absorbing layer can be controlled by changing the thickness and the type of the adhesive layer.

The kind of the adhesive used for the adhesive layer is not particularly limited and examples thereof include urethane resin-based, polyester-based, acrylic resin-based, ethylene vinyl acetate resin-based, polyvinyl alcohol-based, polyamide-based, and silicone-based adhesives. From the viewpoint of adhesive strength, a urethane resin-based adhesive is preferable as the adhesive.

The adhesive layer preferably includes at least one urethane resin adhesive and one or more other adhesives may be used in combination with the urethane resin adhesive.

In the case of providing the adhesive layer, the thickness of the adhesive layer is preferably 3 μm or more and 15 μm or less and more preferably 3 μm or more and 10 μm or less from the viewpoint of adhesive strength and handleability in the case in which the moisture-absorbing material is formed into a packaging material. When the thickness of the adhesive layer is within the above range, both adhesive strength and handleability in the case in which the moisture-absorbing material is formed into a packaging material can be achieved at a higher level.

In addition, when the thickness within the above range is selected, the moisture-absorbing rate of the moisture-absorbing layer can be controlled.

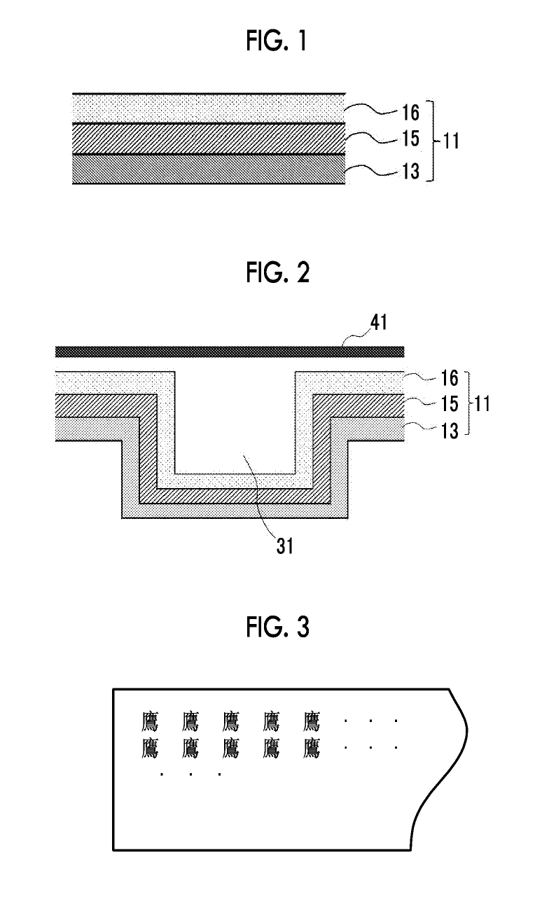

The moisture-absorbing material according to the embodiment of the present invention may be formed by, for example, laminating a polymer layer 16, a moisture-absorbing layer 15, and a moisture-proof layer 13 in this order as shown in FIG. 1 and may further include an adhesive layer formed between the moisture-absorbing layer 15 and the moisture-proof layer 13 by applying an adhesive between the moisture-absorbing layer 15 and the moisture-proof layer 13.

—Method for Producing Moisture-Absorbing Material—

The method for producing a moisture-absorbing material in the present disclosure includes a step of forming a moisture-absorbing layer by forming a layer having a porous structure by applying a coating liquid including amorphous silica, a water-soluble resin, and at least one of plasticizers and resins having a glass transition temperature of 50° C. or lower to any one of a moisture-permeable polymer layer and a moisture-proof layer (for example, a moisture-proof layer) and applying a solution including a moisture-absorbing agent to the porous structure to impregnate the porous structure with the moisture-absorbing agent (moisture-absorbing layer forming step), and a step of laminating the other one of the polymer layer and the moisture-proof layer (for example, a polymer layer) on the moisture-absorbing layer impregnated with the moisture-absorbing agent (lamination step).

In the moisture-absorbing layer configured to have a porous structure using amorphous silica, the moisture-absorbing agent is adsorbed onto the surface of the silica forming the porous structure by applying the moisture-absorbing agent. Thus, a wide hygroscopic surface can be ensured in the moisture-absorbing material and the moisture-absorbing material has a high moisture-absorbing rate and a large moisture absorption capacity. Particularly, in the case in which the porous structure is formed with vapor phase process silica, transparency is imparted and thus the moisture-absorbing material has light transmittance (that is, visibility through a material).

[Moisture-Absorbing Layer Forming Step]

The moisture-absorbing layer forming step in the present disclosure is a step of forming a moisture-absorbing layer by forming a layer having a porous structure by applying a coating liquid including amorphous silica, a water-soluble resin, and at least one of plasticizers and resins having a glass transition temperature of 50° C. or lower to any one of a “moisture-permeable polymer layer” and a moisture-proof layer constituting a moisture-absorbing material and applying a solution including a moisture-absorbing agent to the porous structure to impregnate the porous structure with the moisture-absorbing agent.

The details of the amorphous silica, the water-soluble resin, the plasticizers and the resins having a glass transition temperature of 50° C. or lower are as described above.

(Formation of Layer Having Porous Structure)

The coating liquid can be prepared by mixing amorphous silica, a water-soluble resin, and as required, other components such as a dispersing agent, water, and a crosslinking agent, and dispersing the mixture.

For example, vapor phase process silica particles as a pigment and a dispersing agent are added in water and dispersed using a high-speed rotation wet colloid mill (for example, CLEAMIX, manufactured by M Technique Co., Ltd.) or a liquid-liquid collision dispersing machine (ULTIMIZER, manufactured by Sugino Machine Limited), for example, under the conditions of a high-speed rotation of 10,000 rpm (preferably, from 5,000 to 20,000 rpm) for a predetermined period of time (preferably, from 10 to 30 minutes), and then, a crosslinking agent (for example, boric acid), and a water-soluble resin (preferably an aqueous polyvinyl alcohol solution) are added. Further, other components are added as required and the resultant mixture is dispersed under the same rotation conditions as described above, thereby preparing a coating liquid.

The obtained coating liquid is in a highly homogeneous sol state, and a moisture-absorbing layer with a porous structure having a three-dimensional network structure can be formed by applying the coating liquid to a support by a coating method and drying the applied coating liquid.

In addition, a water dispersion containing amorphous silica and a dispersing agent is prepared as follows. An amorphous silica water dispersion liquid may be prepared in advance and the water dispersion liquid may be added to an aqueous dispersing agent solution. An aqueous dispersing agent solution may be added to an amorphous silica water dispersion liquid or the aqueous dispersing agent solution and the amorphous silica water dispersion liquid may be simultaneously mixed. Further, instead of the amorphous silica water dispersion liquid, powder amorphous silica may be added to the aqueous dispersing agent solution as described above.

After the amorphous silica and the dispersing agent are mixed, the obtained liquid mixture particles are refined using a dispersing machine so that a water dispersion liquid having an average particle diameter of 20 nm to 5,000 nm can be obtained. Particularly, in the case in which vapor phase process silica is used as the amorphous silica, a water dispersion liquid having an average particle diameter of 20 nm to 100 nm can be obtained.

Various conventionally known dispersing machines such as a high speed rotary disperser, a medium stirring type disperser (a ball mill, a sand mill, and the like), a supersonic disperser, a colloid mill disperser, and a high pressure disperser can be used. Among these, a stirring type dispersing machine, a colloid mill dispersing machine, and a high pressure dispersing machine are preferable as the dispersing machine.

In the preparation of the coating liquid, a solvent can be used. Examples of the solvent include water, an organic solvent and a mixed solvent formed of water and an organic solvent. Examples of the organic solvent include alcohols such as methanol, ethanol, n-propanol, i-propanol, and methoxypropanol, ketones such as acetone and methylethylketone, tetrahydrofuran, acetonitrile, ethyl acetate, and toluene.

Coating is performed by, for example, coating methods using a bread coater, an air knife coater, a roll coater, a bar coater, a gravure coater, and a reverse coater.

After the coating liquid is applied, the coating liquid is dried until the moisture-absorbing layer exhibits falling-rate drying. Generally, drying can be performed within a temperature range of 40° C. to 180° C. and a time range of 0.5 minutes to 10 minutes (preferably 0.5 minutes to 5 minutes).

In the case of forming the moisture-absorbing layer having a porous structure, the coating liquid is applied and dried to form a layer having a porous structure (coating layer). Then, a basic compound-containing solution may be applied to the formed layer. In this manner, a moisture-absorbing layer with a porous structure having a satisfactory pore structure can be obtained.

As the method for applying the basic compound-containing solution, a method for further applying the basic compound-containing solution to the moisture-absorbing layer, a method for spraying the basic compound-containing solution using a spray or the like, a method for immersing a support having a coating layer formed in the basic compound-containing solution, and the like can be used.

The basic compound-containing solution contains at least one basic compound.

Examples of the basic compound include ammonium salts of weak acids, alkali metal salts of weak acids (such as lithium carbonate, sodium carbonate, potassium carbonate, lithium acetate, sodium acetate and potassium acetate), alkaline earth metal salts of weak acids (such as magnesium carbonate, barium carbonate, magnesium acetate and barium acetate), ammonium hydroxide, primary to tertiary amines (such as triethylamine, tripropylamine, tributylamine, trihexylamine, dibutylamine and butylamine), primary to tertiary anilines (such as diethylaniline, dibutylaniline, ethylaniline and aniline) and pyridines which may have a substituent (such as 2-aminopyridine, 3-aminopyridine, 4-aminopyridine and 4-(2-hydroxyethyl)-aminopyridine).

Any of the above basic compounds may be used in combination with another basic substance and/or a salt thereof. Examples of another basic substance include ammonia, primary amines such as ethylamine and polyallylamine, secondary amines such as dimethylamine, tertiary amines such as N-ethyl-N-methylbutylamine, hydroxides of alkali metals and hydroxides of alkaline earth metals.

Among these, ammonium salts of weak acids are particularly preferable. The weak acid may be an inorganic or organic acid having a pKa value of 2 or more, and are described in, for example, Handbook of Chemistry; Fundamental Volume II (published by Maruzen Co., Ltd.). Examples of the ammonium salts of weak acids include ammonium carbonate, ammonium hydrogen carbonate, ammonium borate, ammonium acetate and ammonium carbamate. However, the ammonium salts of weak acids are not limited thereto. Among these, ammonium carbonate, ammonium hydrogen carbonate and ammonium carbamate are preferable and are effective in that these compounds do not remain in the layer after drying. The basic compound may be used in combination of two or more thereof

The content of the basic compound (particularly an ammonium salt of a weak acid) in the “basic compound-containing solution” is preferably 0.5% by mass or more and 10% by mass or less, and more preferably 1% by mass or more and 5% by mass or less with respect to the total mass (including the solvent) of the “basic compound-containing solution”. When the content of the basic compound (particularly an ammonium salt of a weak acid) is within the above range, a sufficient degree of curing can be obtained and impairment of a working environment caused by an excessively high ammonia concentration can be avoided.

The basic compound-containing solution can further contain a metal compound, a crosslinking agent, another mordant component, a surfactant and the like as required.

The curing of the film is promoted by using the basic compound-containing solution as an alkali solution. The pH of the basic compound-containing solution (25° C.) is preferably 7.1 or higher, more preferably 8.0 or higher, and still more preferably 9.0 or higher. When the pH is 7.1 or higher, the crosslinking reaction of the water-soluble resin included in the coating liquid is further promoted and cracking of the layer is more effectively prevented.

The basic compound-containing solution can be prepared, for example, by adding a crosslinking agent (such as a boron compound, in an amount of, for example, 0.1% by mass to 1% by mass) and a basic compound (such as ammonium carbonate, in an amount of, for example, 1% by mass to 10% by mass), and, as required, an additive such as a surfactant to ion exchange water, and then stirring the components.

As the coating method for applying the basic compound-containing solution, the same methods as the coating methods of the coating liquid used for forming the moisture-absorbing layer can be used. Among these, in the case in which the basic compound-containing solution is applied, it is preferable that a method in which a coater is not directly brought into contact with a coating layer formed by coating is selected.

Regarding the amount of the basic compound-containing solution applied, from the viewpoint of moisture absorbing performance of the moisture-absorbing layer, the amount of the moisture-absorbing agent applied is preferably 1 g/m² or more and 20 g/m² or less, and the amount of the moisture-absorbing agent applied is more preferably 3 g/m² or more and 12 g/m² or less.

After the basic compound-containing solution is applied, heating is performed generally at a temperature of from 40° C. to 180° C. for 0.5 minutes to 30 minutes and drying and curing are performed. Among these, it is preferable that heating is performed at a temperature of from 40° C. to 150° C. for 1 minute to 20 minutes. For example, in the case in which the solution contains borax and boric acid as boron compounds, it is preferable that heating is performed at a temperature of from 60° C. to 100° C. for 0.5 minutes to 15 minutes.

The basic compound-containing solution and the coating liquid for forming a moisture-absorbing layer may be simultaneously applied. In this case, the coating liquid and the basic compound-containing solution are simultaneously applied (applied in a multilayered manner) to the polymer layer (or the moisture-proof layer) such that the coating liquid is brought into contact with the polymer layer (or the moisture-proof layer), and then dried and cured. Thus, a layer having a porous structure can be formed.

The simultaneous coating (multilayer coating) can be performed by a coating method using an extrusion die coater, a curtain flow coater or the like. The coating layer formed after the simultaneous coating is dried. In this case, drying is performed by heating the coating layer generally at a temperature of 40° C. to 150° C. for 0.5 minutes to 10 minutes. Heating is preferably performed at a temperature of 40° C. to 100° C. for 0.5 minutes to 5 minutes. For example, in the case in which borax and boric acid are used as the crosslinking agent containing the basic compound-containing solution, heating is preferably performed at a temperature of 60° C. to 100° C. for 5 minutes to 20 minutes.

(Formation of Moisture-Absorbing Layer)

As described above, the moisture-absorbing layer is formed by forming a layer having a porous structure and then applying a solution including a moisture-absorbing agent to this layer to impregnate the porous structure with the moisture-absorbing agent.

As the method for applying the solution including a moisture-absorbing agent, a method for applying the solution to the moisture-absorbing layer, a method for spraying the solution using a spray or the like, a method for immersing the layer having a porous structure in a solution, and the like can be used.

As a coating method in the case in which the solution including a moisture-absorbing agent is applied by coating, the same coating methods as the coating methods of the coating liquid for forming a moisture-absorbing layer can be used.

The solution including a moisture-absorbing agent contains at least one moisture-absorbing agent and may contain other components such as a surfactant or a solvent as required.

The solution including a moisture-absorbing agent can be prepared, for example, by adding a moisture-absorbing agent (for example, an inorganic salt) and an additive such as a surfactant as required to ion exchange water, and then stirring the components.

Regarding the amount of the solution including a moisture-absorbing agent applied, from the viewpoint of the amount of moisture absorption and the moisture-absorbing rate of the moisture-absorbing layer, the amount of the moisture-absorbing agent applied is preferably 1 g/m² or more and 20 g/m² or less, and the amount of the moisture-absorbing agent applied is more preferably 3 g/m² or more and 12 g/m² or less.

After the solution including a moisture-absorbing agent is applied, heating is performed generally at a temperature of from 40° C. to 180° C. for 0.5 minutes to 30 minutes and drying and curing are performed. Among these, it is preferable that heating is performed at a temperature of from 40° C. to 150° C. for 1 minute to 20 minutes. For example, in the case in which the above-described solution contains borax and boric acid as boron compounds, heating is preferably performed at a temperature of from 60° C. to 100° C. for 0.5 minutes to 15 minutes.

[Lamination Step]

In the lamination step in the present disclosure, the other one of the above-described polymer layer and the moisture-proof layer is laminated on the moisture-absorbing layer formed by impregnation with the moisture-absorbing agent in the above-described moisture-absorbing layer forming step.

For example, a method for forming the moisture-proof layer (or the polymer layer) is not particularly limited and the moisture-proof layer may be formed by bonding a material having moisture-proof properties (or a material having moisture permeability) to the moisture-absorbing layer provided on the polymer layer (or the moisture-proof layer). In addition, the moisture-proof layer (or the polymer layer) may be formed by preparing a coating liquid including a material having moisture-proof properties (or a material having moisture permeability) and applying the coating liquid to the moisture-absorbing layer.

The details of the material having moisture-proof properties are as described above.

<Blister Pack>

A blister pack according to the embodiment of the present invention includes the above-described moisture-absorbing material according to the embodiment of the present invention in which a concave portion which becomes a storage portion is formed, and a substrate that is bonded to a non-concave portion-forming portion on the side closer to the opening surface of the concave portion of the moisture-absorbing material, and is formed to store a desired contents to be stored in the concave portion.

Since the blister pack according to the embodiment of the present invention is a packaging material using the above-described moisture-absorbing material according to the embodiment of the preset invention, compared to a conventional one, the appearance is satisfactory and further excellent hygroscopicity is achieved.

The details and a preferable embodiment of the moisture-absorbing material constituting the blister pack are as described above.

In addition, the substrate is not particularly limited and may be appropriately selected according to purposes and applications. Examples of the substrate include a plate of plastic (for example, polypropylene resin, polyvinyl chloride resin, or the like), and a metal foil such as an aluminum foil.

As shown in FIG. 2, the blister pack may be a packaging material configured to include the moisture-absorbing material 11 in which a concave portion 31 which becomes a storage portion is formed by forming the moisture-absorbing material in advance, and a plate-like counter substrate 41 that is bonded to the polymer layer 16 in a non-concave portion-forming portion on the side closer to the opening surface of the concave portion 31 of the moisture-absorbing material 11. In this case, a packaging material can be formed by applying heat from the side closer to the moisture-proof layer 13 of the moisture-absorbing material 11 for compression bonding or the like and bonding the moisture-absorbing material 11 and the counter substrate 41.

The application of heat can be performed by bringing a heated rod or plate into contact with the layers for heating or by impulse sealing and ultrasonic sealing, in addition to hot plate sealing, by heating compression bonding.

### EXAMPLES

In the following, the embodiments of the present invention will be described in more detail with reference to examples. However, the present embodiments are not limited to the following examples as long as these embodiments do not depart from the scope thereof. Moreover, the term “part(s)” and “%” are based on mass unless specifically stated otherwise.

### Example 1

### Production of Moisture-Proof Layer

As a material for forming a moisture-proof layer of a moisture-absorbing film to be prepared, a polyvinyl chloride (PVC) substrate (thickness: 250 pin, moisture permeability: 1 g/m²·day (measured by a method prescribed in JIS Z 0208); hereinafter, referred to as a PVC substrate) was prepared.

<Formation of Moisture-Absorbing Layer>

—Preparation of Coating Liquid for Forming Moisture-Absorbing Layer—

(1) Vapor phase process silica particles, (2) ion exchange water, (3) SHAROL DC-902P, and (4) ZIRCOSOL ZA-30 shown in the following composition were mixed. The mixture was dispersed using a liquid-liquid impact type dispersing machine (ULTIMAIZER, manufactured by Sugino Machine Limited) and then, the obtained dispersion liquid was heated to 45° C. and maintained for 20 hours. Thereafter, the temperature of the dispersion liquid was maintained at 30° C. and (5) an aqueous boric acid solution, (6) glycerol, and (7) a polyvinyl alcohol solution were added to the dispersion liquid. Thus, a coating liquid for forming a moisture-absorbing layer was prepared.

(Composition of Coating Liquid for Forming Moisture-Absorbing Layer)

(1) Vapor phase process silica particles (amorphous silica) . . . 8.9 parts

(AEROSIL 300SF75, manufactured by Nippon Aerosil Co., Ltd., average primary particle diameter: 7 nm, average secondary particle diameter: 20 nm)

(2) Ion exchange water . . . 47.3 parts

(3) “SHAROL DC-902P” (51.5% aqueous solution) . . . 0.8 parts

(dispersing agent, nitrogen-containing organic cationic polymer, manufactured by DKS Co., Ltd.)

(4) “ZIRCOSOL ZA-30” . . . 0.5 parts

(manufactured by Daiichi Kigenso Kagaku Kogyo Co., Ltd., zirconyl acetate)

(5) Boric acid (5% aqueous solution) . . . 6.6 parts

(6) Glycerol (plasticizer; boiling point: 290° C.) . . . 0.9 parts

(7) Polyvinyl alcohol (water-soluble resin) solution . . . 26.0 parts

—Composition of Polyvinyl Alcohol Solution—
JM33 . . . 1.81 parts

(polyvinyl alcohol (PVA); degree of saponification: 95.5%, degree of polymerization: 3,300, manufactured by Japan Vam & Poval Co., Ltd.)
HPC-SSL . . . 0.08 parts

(water-soluble cellulose, manufactured by Nippon Soda Co., Ltd.)
Ion exchange water . . . 23.5 parts
Diethyleneglycol monobutylether . . . 0.55 parts

(BUTYCENOL 20P, manufactured by Kyowa Hakko Chemical Co., Ltd.)
Polyoxyethylene lauryl ether (surfactant) . . . 0.06 parts

(EMULGEN 109P, manufactured by Kao Corporation)

—Formation of Moisture-Absorbing Layer—

The PVC substrate (moisture-proof layer) was coated with the coating liquid for forming a moisture-absorbing layer obtained in the above using an extrusion die coater such that the coating amount became 165 g/m².

The coating layer formed by coating was dried with a hot air dryer at 80° C. (at a wind speed of 3 to 8 m/second) until the concentration of the solid content of the coating layer became 36%. The coating layer exhibited a constant drying rate during the drying. Immediately after the drying, the coating layer was immersed for 3 seconds into a basic compound-containing solution having the following composition and 13 g/m² of the basic compound-containing solution was applied to the coating layer. The resultant was further dried at 72° C. for 10 minutes, and thus, a layer having a porous structure was formed.

Thereafter, a moisture-absorbing agent coating liquid having the following composition was applied to the formed layer using an extrusion die coater such that the coating amount became 50 g/m², and the coating layer was dried with a hot air dryer at 80° C. (at a wind speed of 3 to 8 m/second). Thus, a moisture-absorbing layer having a thickness of 40 μm was formed.

The formed moisture-absorbing layer had a void volume of 60% and an average pore diameter of 20 nm.

The average pore diameter was measured by the mercury intrusion method using Shimadzu AUTOPORE 9220 (manufactured by Shimadzu Corporation). The measurement of the void volume will be described later.

The coating amount of the calcium chloride (CaCl₂; moisture-absorbing agent) in the moisture-absorbing layer was 7.5 g/m².

(Composition of Basic Compound-Containing Solution)

(1) Boric acid . . . 0.65 parts

(2) Ammonium carbonate (First grade: manufactured by Kanto Chemical Co., Inc.) . . . 5.0 parts

(3) Ion exchange water . . . 93.75 parts

(4) Polyoxyethylene lauryl ether (surfactant) . . . 0.6 parts

(EMULGEN 109P, manufactured by Kao Corporation)

(Composition of Moisture-Absorbing Agent Coating Liquid)

(1) Ion exchange water . . . 84.4 parts

(2) Calcium chloride (CaCl₂; moisture-absorbing agent) . . . 15 parts

(3) Polyoxyethylene lauryl ether (surfactant) . . . 0.6 parts

(“EMULGEN 109P”, manufactured by Kao Corporation)

The surface of the obtained moisture-absorbing layer was observed with an electron microscope (JEM 2100, manufactured by JEOL Ltd.) and the projected area of each of 100 silica particles at an arbitrary position on the surface was obtained. When a circle having an area equal to the projected area is assumed, the individual particle diameter was obtained and the diameters of 100 silica particles were simply averaged, thereby obtaining an average primary particle diameter of the amorphous silica.

In addition, the surface of the obtained moisture-absorbing layer was observed with an electron microscope (S-4700, manufactured by HITACHI Ltd.) at an accelerating voltage of 10 kV and the projected area of each of 100 aggregated particles at an arbitrary position on the surface was obtained. When a circle having an area equal to the projected area is assumed, each particle diameter was obtained and the diameters of 100 aggregated particles were simply averaged, thereby obtaining an average secondary particle diameter of the amorphous silica.

<Formation of Moisture-Permeable Polymer Layer>

A heat sealing agent (product number: T-235 (L) CLEAR manufactured by Leader Co., Ltd.) was applied to the surface of the moisture-absorbing layer formed on the moisture-proof layer as described in the above description with a gravure coater such that the film thickness after drying became 3 g/m². Then, until the coating layer was formed into a film, the coating layer was maintained at 60° C. and dried. In this manner, the polymer layer was laminated.

Regarding the moisture permeability of the laminated polymer layer, the moisture permeability was measured by a method prescribed in JIS Z 0208, and it was confirmed that the polymer layer had moisture permeability.

In this manner, a moisture-absorbing film having a lamination structure of the PVC substrate (moisture-proof layer)/the moisture-absorbing layer/the moisture permeable polymer layer was produced.

—Formation of Moisture-Absorbing Film—

The moisture-absorbing film obtained in the above was pre-heated at 130° C. for 2 seconds using a hot plate and then placed between concave and convex dies heated to 100° C. to produce a film molded article in which a concave storage portion is formed as shown in FIG. 2.

Thereafter, a desired tablet was stored in the concave storage portion (so-called a PTP pocket) of the produced film molded article, and an aluminum foil was overlapped with the film molded article by being brought into contact with the polymer layer of the non-concave portion-forming portion in which a concave portion is not formed. While applying heat to the non-concave portion-forming portion, the film molded article and the aluminum foil were subjected to compression bonding. Thus, a blister pack could be produced.

<Evaluation>

The thus-obtained film molded articles were subjected to the following evaluations. The evaluation results are shown in Table 1 below.

—Visibility—

In the concave portion of the obtained film molded article, as shown in FIG. 3, with respect to each of a yellow ink, a magenta ink, a cyan ink, and a black ink, an image in which characters of 12 points in Mincho typeface are arranged was disposed, and the visibility of the character when the inside of the pack was observed from the side closer to the moisture-proof layer was evaluated based on the following evaluation criteria.

<Evaluation Criteria>

A: The transparency of the moisture-absorbing film was high and the character in FIG. 3 could be easily visibly recognized.

B: The moisture-absorbing film had transparency and the character in FIG. 3 could be visibly recognized.

C: Since the transparency of the moisture-absorbing film was slightly low, the character in FIG. 3 could be barely visibly recognized but the character in FIG. 3 could be visibly recognized.

D: The transparency of the moisture-absorbing film was extremely low and the visual recognition of the character in FIG. 3 was difficult.

—Cracking—

The obtained film molded article was visually observed and whether cracking occurred in the moisture-absorbing layer was evaluated based on the following evaluation criteria.

<Evaluation Criteria>

A: Cracking did not occur.

B: Very slight cracking occurred but normal handling was not interrupted.

C: Slight cracking occurred but was within an allowable range.

D: Cracking was remarkably recognized and there was a problem in practical use.

—Moldability—

Regarding the height of the concave and convex portions of the concave and convex dies, a small tablet having a height of 2 mm and an outer diameter of 2 mm was placed in the film molded article and the size of the concave and convex portions was functionally evaluated by visual observation.

<Evaluation Criteria>

A: The film molded article was molded according to the shape of the die and had a sufficient space for placing the tablet.

B: The film molded article had a slightly shallow or small PTP pocket but had a sufficient space for placing the tablet.

C: The film molded article had a relatively shallow or small PTP pocket but the table could be placed.

D: The table could not be placed in the film molded article.

—Void Volume—

A void volume per unit thickness was calculated from the void volume (ml/m²) and the thickness (μm) of the moisture-absorbing layer to obtain a void volume (%).

Here, the thickness of the moisture-absorbing layer was obtained from the result of observation using an optical microscope. In addition, regarding the void volume of the moisture-absorbing layer, 1 ml of diethylene glycol was added dropwise onto the moisture-absorbing layer, the surface to which diethylene glycol was added dropwise was wiped with a cloth after one minute had passed, and a change in weight before and after dropwise addition (the amount of liquid absorbed per unit area) was calculated. This calculated value was set to a void volume.

### Examples 2 to 13 and Comparative Examples 1 to 3

Moisture-absorbing films were produced and blister packs were formed in the same manner as in Example 1 except that the composition of the moisture-absorbing agent coating liquid in Example 1 was changed as shown in Table 1 below.

TABLE 1

| | Moisture-absorbing layer | | | | | | | | | | |
|---|---|---|---|---|---|---|---|---|---|---|---|
| | | Plasticizer | | | Tg ≦ 50° C. resin | | | | | | |
| | | | | Amount | | | Amount | | | | |
| | | | Boiling | ratio of | | Tg of | ratio of | Void | | | |
| | Water-soluble | | point | plasticizer | | resin | resin | volume | Evaluation | | |
| | resin | Type | [° C.] | to silica | Type | [° C.] | to silica | [%] | Visibility | Cracking | Moldability |
| Example 1 | Included | Glycerol | 290 | 10% | — | — | — | 60 | A | A | A |
| Example 2 | Included | Glycerol | 290 | 5% | — | — | — | 62 | A | B | A |
| Example 3 | Included | Polyethylene | 300 or | 10% | — | — | — | 58 | B | A | A |
| | | glycol | higher | | | | | | | | |
| Example 4 | Included | Polyethylene | 300 or | 5% | — | — | — | 60 | A | B | A |
| | | glycol | higher | | | | | | | | |
| Example 5 | Included | Diethylene | 244 | 10% | — | — | — | 58 | B | A | A |
| | | glycol | | | | | | | | | |
| Example 6 | Included | Diethylene | 244 | 5% | — | — | — | 60 | A | B | A |
| | | glycol | | | | | | | | | |
| Example 7 | Included | — | | — | EVA | 0 | 20% | 55 | C | A | A |
| Example 8 | Included | — | | — | EVA | 0 | 10% | 58 | B | B | A |
| Example 9 | Included | — | | — | SBR1 | 27 | 20% | 54 | C | A | A |
| Example 10 | Included | — | | — | SBR1 | 27 | 10% | 58 | A | B | A |
| Example 11 | Included | Glycerol | 290 | 2% | — | — | — | 61 | A | C | A |
| Example 12 | Included | — | | — | EVA | 0 | 3% | 60 | A | C | B |
| Example 13 | Included | Glycerol | 290 | 5% | EVA | 0 | 10% | 57 | B | A | A |
| Comparative | Included | — | | — | SBR2 | 58 | 20% | 54 | C | D | B |
| Example 1 | | | | | | | | | | | |
| Comparative | Included | — | | — | — | — | — | 63 | C | D | C |
| Example 2 | | | | | | | | | | | |

| | | | | | | | | | |
|---|---|---|---|---|---|---|---|---|---|
| Comparative | Not included | Glycerol | 290 | 10% | — | — | — | — | Not able to form moisture-absorbing layer |
| Example 3 | | | | | | | | | |

The details of the components in Table 1 are as follows.
EVA: ethylene-vinyl acetate copolymer (Tg=0° C. (resin having Tg of 50° C. or lower); EVA TEX 60, manufactured by Denka Company Limited)
SBR 1: styrene-butadiene copolymer (Tg=27° C. (resin having Tg of 50° C. or lower); NIPOL LX415M, manufactured by Zeon Corporation)
SBR 2: styrene-butadiene copolymer (Tg=58° C. (resin having Tg of 50° C. or lower); NIPOL 2507H, manufactured by Zeon Corporation)

As shown in Table 1, in the moisture-absorbing films of Examples, compared to Comparative Examples, the occurrence of cracking was remarkably reduced and visibility and moldability were excellent.

### INDUSTRIAL APPLICABILITY

The moisture-absorbing material according to the embodiment of the present invention is suitable for a packaging material which requires hygroscopicity, and is suitably used as, for example, a material for molding a blister pack (also referred to as PTP (Press Through Package) package) for storing medicines, foods, and the like for preservation and transportation of medicines, foods, and the like.

The present application claims priority from JP2014-083199, the content of which is hereby incorporated by reference in their entirety.

All the documents, patent applications and technical standards described in the specification are incorporated into the specification for reference to the same extent as cases in which it is specifically and respectively described that the respective documents, patent applications and technical standards are incorporated for reference.

What is claimed is:

1. A moisture-absorbing material comprising, in the following order:
a moisture-permeable polymer layer;
a moisture-absorbing layer having a porous structure and including amorphous silica, a water-soluble resin, a moisture-absorbing agent, and at least one selected from plasticizers and resins having a glass transition temperature of 50° C. or lower; and
a moisture-proof layer.

2. The moisture-absorbing material according to claim 1,
wherein the plasticizer has a boiling point of 150° C. or higher.

3. The moisture-absorbing material according to claim 1,
wherein the plasticizer is a glycol-based compound.

4. The moisture-absorbing material according to claim 1,
wherein the moisture-absorbing agent is an inorganic salt.

5. The moisture-absorbing material according to claim 4,
wherein the inorganic salt is calcium chloride.

6. The moisture-absorbing material according to claim 1,
wherein the amorphous silica is vapor phase process silica.

7. The moisture-absorbing material according to claim 1,
wherein the water-soluble resin is a polyvinyl alcohol-based resin.

8. The moisture-absorbing material according to claim 7,
wherein the polyvinyl alcohol-based resin is polyvinyl alcohol having a degree of saponification of 99% or less and a degree of polymerization of 3,300 or more.

9. The moisture-absorbing material according to claim 1,
wherein the resin having a glass transition temperature of 50° C. or lower is a vinyl-based copolymer.

10. The moisture-absorbing material according to claim 9,
wherein the vinyl-based copolymer is at least one selected from a styrene-butadiene copolymer, an acrylic polymer, an ethylene-vinyl acetate copolymer, and a vinyl chloride-vinyl acetate copolymer.

11. The moisture-absorbing material according to claim 1,
wherein a content of the plasticizer and the resin having a glass transition temperature of 50° C. or lower is 5% by mass or more and 15% by mass or less with respect to the amorphous silica.

12. The moisture-absorbing material according to claim 1 that is used for a blister pack.

13. A blister pack comprising:
the moisture-absorbing material according to claim 1 in which a concave portion which becomes a storage portion is formed; and
a substrate that is bonded to the polymer layer of a non-concave portion-forming portion on the side closer to the opening surface of the concave portion of the moisture-absorbing material.

14. A method for producing a moisture-absorbing material comprising:
forming a moisture-absorbing layer by forming a layer having a porous structure by applying a coating liquid including amorphous silica, a water-soluble resin, and at least one selected from plasticizers and resins having a glass transition temperature of 50° C. or lower to any one of a moisture-permeable polymer layer and a moisture-proof layer and applying a solution including a moisture-absorbing agent to the porous structure to impregnate the porous structure with the moisture-absorbing agent; and
laminating the other one of the polymer layer and the moisture-proof layer on the moisture-absorbing layer impregnated with the moisture-absorbing agent.

15. The method for producing a moisture-absorbing material according to claim 14,
wherein the amorphous silica is vapor phase process silica.
